(19) United States
(12) Patent Application Publication
(10) Pub. No.: US 2015/0062029 A1
(43) Pub. Date: Mar. 5, 2015

(54) INFORMATION PROCESSING APPARATUS AND COMPUTER PROGRAM

(71) Applicant: TOSHIBA TEC KABUSHIKI KAISHA, Tokyo (JP)

(72) Inventor: Seiji Saito, Mishima-shi (JP)

(21) Appl. No.: 14/340,791

(22) Filed: Jul. 25, 2014

(30) Foreign Application Priority Data
Aug. 29, 2013 (JP) 2013-177877

(51) Int. Cl. G06F 3/041

(52) U.S. Cl. CPC G06F 3/0416; G06F 3/0412; G06F 2203/04104
USPC 345/173

(57) ABSTRACT

An information processing apparatus according to an embodiment includes a touch panel display and a control section. The touch panel display includes a polarizing filter. The control section controls display of the touch panel display such that display content visually recognized via the polarizing filter is displayed in a regular direction in each of positions of a plurality of users present around side surfaces of the touch panel display when a display operation surface of the touch panel display is directed in an upward direction.

### CROSS-REFERENCE TO RELATED APPLICATION

This application is based upon and claims the benefit of priority from Japanese Patent Application No. 2013-177877, filed Aug. 29, 2013, the entire contents of which are incorporated herein by reference.

### FIELD

Embodiments described herein relate generally to a technique for controlling display and operation on a touch panel.

### BACKGROUND

There is a computer that adopts, as an input device, a multi-touch panel that detects a plurality of touches. There is a tabletop computer that adopts, as a table top, the touch panel increased in size. The tabletop computer allows simultaneous operation by a large number of people and enables the people to hold a meeting and a presentation.

A user brings a fingertip or a nib into contact with an image region displayed on the touch panel and slides the fingertip or the nib. The image moves according to the operation. The user can perform rotation, enlargement, reduction, and the like of the image by bringing a plurality of fingers or nibs into contact with an image and performing predetermined gesture operation.

In such a tabletop computer, the number of people who can stand in a regular position with respect to a displayed image (a position where a vertical state of an image, a character, and the like is recognized as a correct direction) is limited. In a small meeting of about two people, users often sit to face each other across the tabletop computer. When the users have a meeting in this facing state, if image display of the tabletop computer is set in a regular direction for one user, the image display is in a vertically reversed direction for the other user. The user not present in the regular direction with respect to the image has poor visibility and poor operability.

### DESCRIPTION OF THE DRAWINGS

FIG. 1 is a diagram showing an external view of a tabletop information processing apparatus in a first embodiment;

FIG. 2 is a diagram showing a hardware configuration example of the tabletop information processing apparatus;

FIG. 3 is a diagram of the tabletop information processing apparatus visually recognized from the upper side;

FIG. 4A is a diagram showing an example of pixel lines of a touch panel display;

FIG. 4B is a diagram for explaining how an image is seen when the image is visually recognized via a lenticular lens;

FIGS. 5A and 5B are diagrams showing an example concerning how objects are seen from each of users facing each other in the first embodiment;

FIG. 6 is a diagram for explaining display conversion according to the first embodiment;

FIGS. 7A to 7C are diagrams showing problems that occur when the users move the objects;

FIGS. 8A and 8B are diagrams for explaining causes of and measures against the problems shown in FIGS. 7A to 7C;

FIGS. 9A and 9B are diagrams showing a position of a camera and an image pickup range of the camera in the first embodiment;

FIG. 10 is a flowchart for explaining an operation example in the first embodiment; and

FIGS. 11A and 11B are diagrams for explaining a display example in a second embodiment.

### DETAILED DESCRIPTION

Embodiments have been devised to solve the problems and it is an object of the embodiments to provide a technique for preventing visibility of an image from being deteriorated irrespective of in which direction the image is viewed.

An information processing apparatus according to an embodiment includes a touch panel display and a control section. The touch panel display includes a polarizing filter. The control section controls display of the touch panel display such that display content visually recognized via the polarizing filter is displayed in a regular direction in each of positions of a plurality of users present around side surfaces of the touch panel display when a display operation surface of the touch panel display is directed in an upward direction.

The information processing apparatus (a computer) in this embodiment displays an image viewed from right opposite positions for each of users according to positions where the users are present. The information processing apparatus reflects operation on the displayed image in the right opposite positions according to standing positions of the users.

### First Embodiment

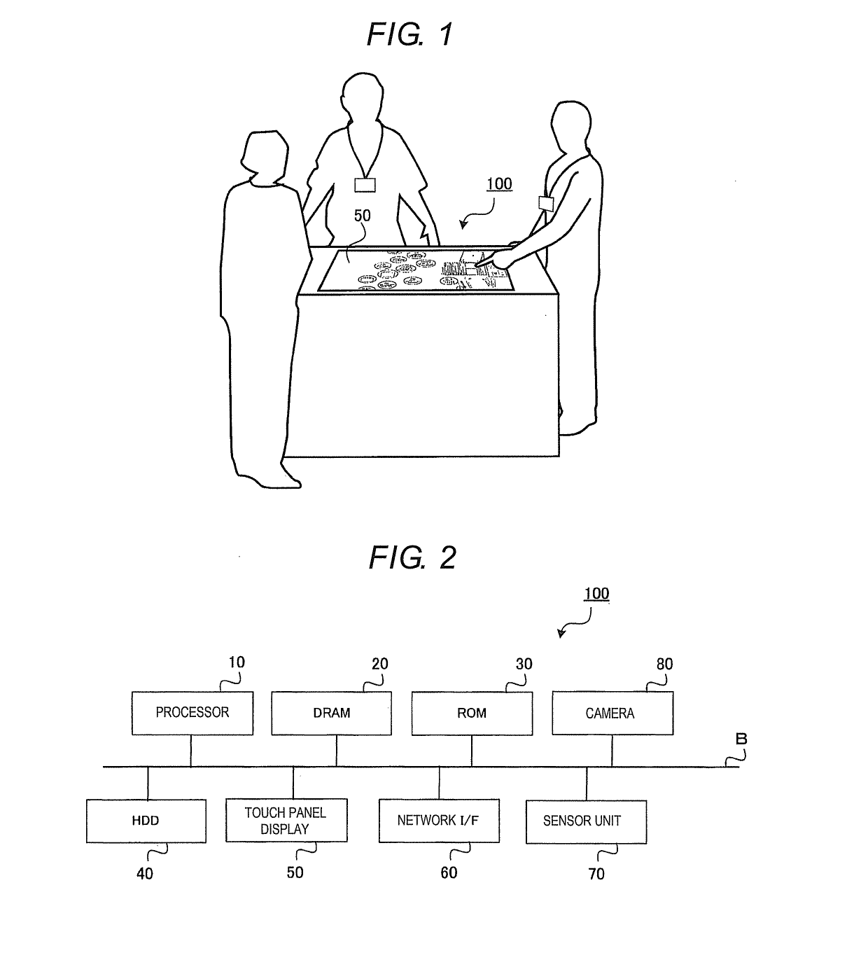

A form of a first embodiment is explained below with reference to the drawings. FIG. 1 is a diagram showing an external view of a tabletop information processing apparatus in this embodiment. A tabletop information processing apparatus 100 is an information processing apparatus of a table type (a tabletop type). A large touch panel display 50 for operation display is arranged on a top plate surface of the tabletop information processing apparatus 100.

In the touch panel display 50, a multi-touch sensor (an input section), which simultaneously detects a plurality of contact positions, is stacked and arranged on a panel-type display section. An image on a screen can be controlled by a fingertip or a nib. The touch panel display 50 enables display of various content images. The touch panel display 50 also plays a role of a user interface for an operation input.

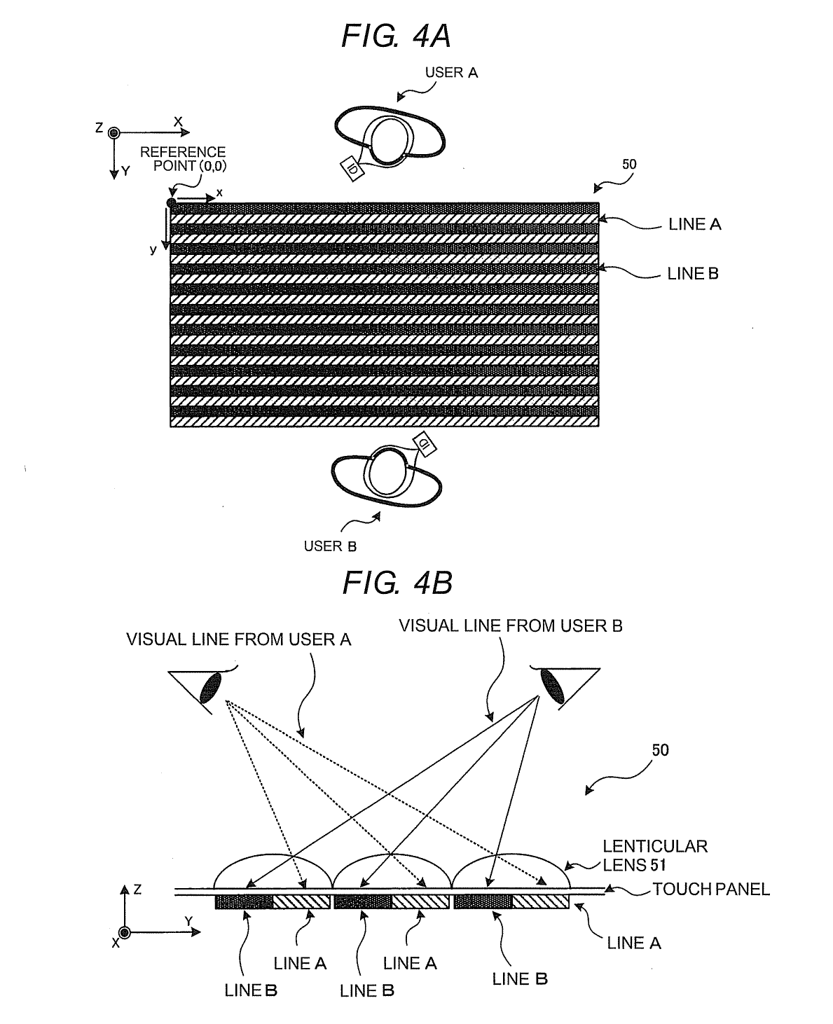

On a surface layer of an operation surface of the touch panel display 50, a lenticular lens 51 (see FIG. 4B) is stacked and arranged. The lenticular lens 51 is a lens that changes an image according to a viewing angle.

FIG. 2 is a block diagram showing an example of a hardware configuration on the inside of the tabletop information processing apparatus 100. The tabletop information processing apparatus 100 includes a processor 10, a DRAM (Dynamic Random Access Memory) 20, a ROM (Read Only Memory) 30, a HDD (Hard Disk Drive) 40, a touch panel display 50, a network I/F (Interface) 60, a sensor unit 70, and a camera 80. These devices perform transmission and reception of control signals and data one another through a communication bus B.

The processor 10 is an arithmetic processing unit such as a CPU (Central Processing Unit). The processor 10 loads computer programs stored in the ROM 30, the HDD 40, and the like to the DRAM 20 and arithmetically executes the computer programs to perform various kinds of processing according to the computer programs. The DRAM 20 is a volatile main storage device. The ROM 30 is a nonvolatile storage device that permanently stores the computer programs. A BIOS (Basic Input Output System) and the like used during a system start are stored. The HDD 40 is a nonvolatile auxiliary storage device capable of permanently storing the computer programs. The HDD 40 stores data and computer programs to be used by a user.

The touch panel display 50 includes an input section of a touch panel and a display section of a flat panel. The touch panel is adapted to multi-touch for detecting a plurality of simultaneous contacts. The touch panel can obtain coordinate values (an x value and a y value) corresponding to a contact position. The flat panel includes light-emitting elements for display over an entire panel surface. The touch panel display 50 includes the lenticular lens 51 on an upper layer thereof.

The network I/F 60 is a unit that performs communication with an external apparatus. The network I/F 60 includes a LAN (Local Area Network) board. The network I/F 60 includes a device conforming to a short-range radio communication standard and a connector conforming to a USB (Universal Serial Bus) standard.

The sensor unit 70 includes sensors 70A to 70D explained below. The sensor unit 70 is a unit that detects an ID (Identification) card owned by the user and reads information stored in the ID card. The read information is used for login authentication and the like for the tabletop information processing apparatus 100. The ID card is a noncontact IC card. At least identification information of the user is stored in the ID card.

The camera 80 is located above the touch panel display 50 and arranged to set a downward direction as an image pickup direction. The camera 80 picks up an image of the entire surface of the touch panel display 50. The arrangement of the camera 80 is explained below.

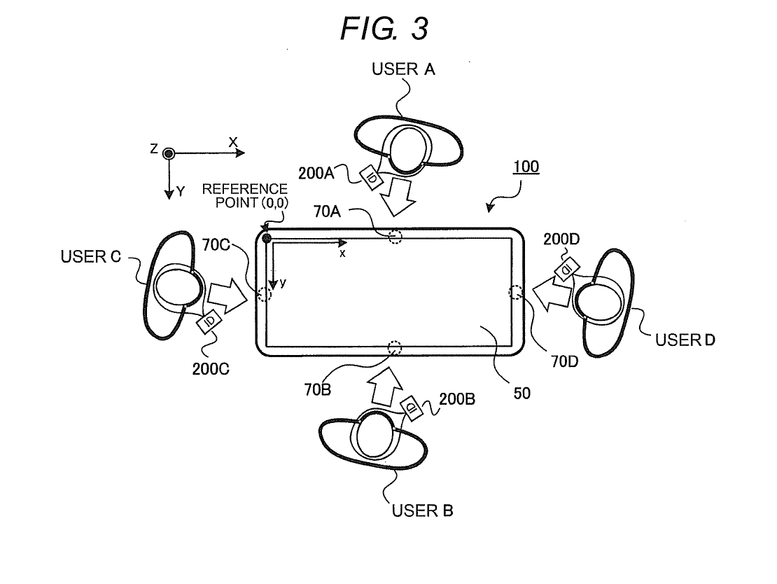

FIG. 3 is a plan view of the tabletop information processing apparatus 100 visually recognized from the upper side. The tabletop information processing apparatus 100 enables simultaneous login of a plurality of users. In this example, the sensors 70A to 70D included in the sensor unit 70 are respectively arranged in the centers of four sides near the top plate. If users carrying ID cards 150A to 150D approach the sensors 70A to 70D, the sensor unit 70 reads information stored in the ID card and login authentication is performed. If the information stored in the ID card is registered in the HDD 40 or an external authentication mechanism beforehand, authentication is matched.

The tabletop information processing apparatus 100 displays a screen for holding a meeting or the like to the users who finish the authentication. The users perform document editing, browsing of materials and Web pages, and the like on the screen. Movement, enlargement, reduction, rotation, selection, deletion, and the like of these objects to be displayed (a displayed image and an aggregate of data tied to the image are referred to as objects) can be performed according to predetermined operation of the users using a publicly-known technology.

In FIG. 3 and subsequent figures, spatial coordinate systems are indicated by uppercase characters X, Y, and Z and coordinate systems of the touch panel display 50 and coordinate systems of an obtained image are indicated by lowercase characters x and y. These coordinate systems are common to all the figures.

It is explained below how the touch panel display 50 is seen when visually recognized via the lenticular lens 51. A control method of the touch panel display 50 is also explained. FIG. 4A is a diagram showing lines of pixels of the display section. The lines are formed by arranging the pixels of the touch panel display 50 in the x-axis direction. Hatched lines are referred to as lines A. Black-shaded lines are referred to as lines B. The display section of the touch panel display 50 displays, according to an instruction of the processor 10, images such that different images are projected by the lines A and the lines B.

The users can view only the black-shaded lines B when visually recognizing the touch panel display 50 from one direction (e.g., a solid line arrow shown in FIG. 4B) via the lenticular lens 51. The users can view only the hatched lines A when visually recognizing the touch panel display 50 from another direction (e.g., a broken line arrow in FIG. 4B) via the lenticular lens 51. In this example, a user A can visually recognize, with polarization of the lenticular lens 51, an image projected by the lines A and cannot visually recognize an image projected by the lines B. On the other hand, a user B can visually recognize the image projected by the lines B and cannot visually recognize the image projected by the lines A. As the touch panel display 50 including the lenticular lens 51, the touch panel display of the related art may be adopted.

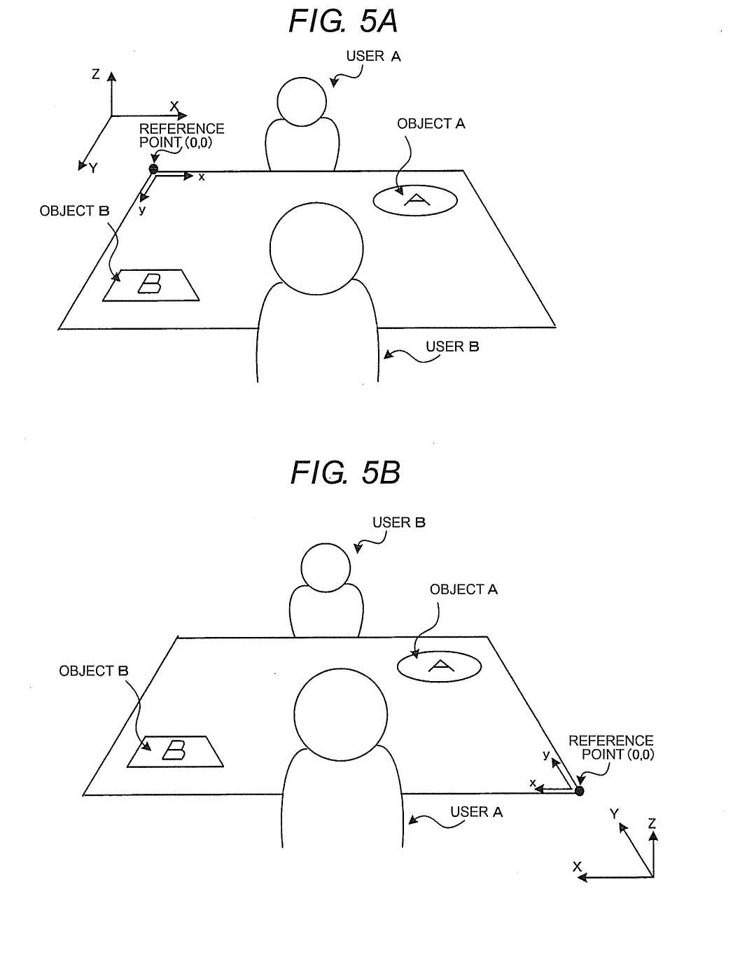

The processor 10 controls the display of the touch panel display 50 such that displayed content visually recognized via the lenticular lens 51 is displayed in the regular direction for each of the user A and the user B. FIGS. 5A and 5B are diagrams showing how objects A and B are seen from each of facing users. FIG. 5A shows how the objects A and B are seen from the user B shown in FIG. 4A. FIG. 5B shows how the objects A and B are seen from the user A. In both the directions from the users A and B, the objects A and B are displayed in the regular direction.

If a reference point and the directions of the x axis and the y axis of the touch panel display 50 are as shown in FIGS. 4A and 4B and 5A and 5B, a position where the objects A and B can be regularly seen without being vertically reversed is the position of the user B. In the position of the user A, the objects A and B are visually recognized as being vertically reversed in the configuration in the past. In this embodiment, the processor 10 causes, by changing a mode, the touch panel display 50 to display the lines (the lines arrayed in the x-axis direction) to be different from each other. The processor 10 causes the touch panel display 50 to display the black-shaded lines B shown in FIGS. 4A and 4B as they are and display the hatched lines A with a displayed image on the lines B vertically reversed on the hatched lines A. A screen controlled in this way is visually recognized via the lenticular lens 51. Consequently, even in the position of the user A, it is possible to visually recognize the objects A and B in the regular direction without being vertically reversed.

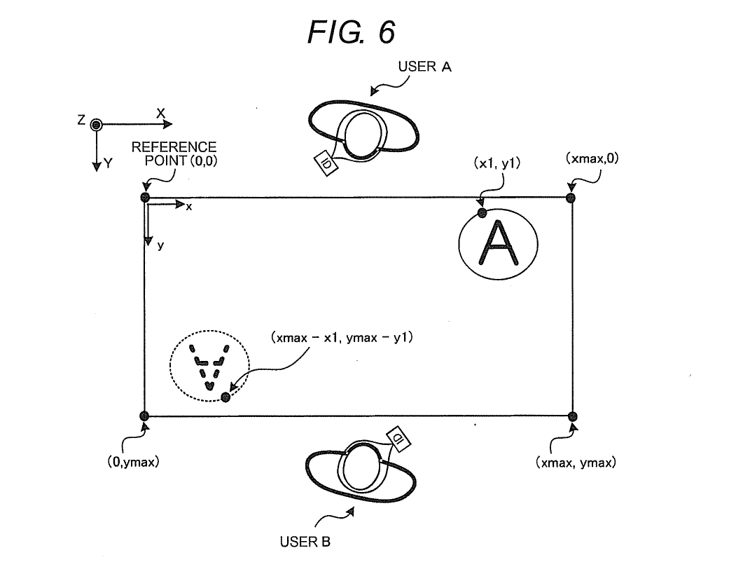

The lines B are displayed in the regular direction when being displayed as they are. However, the lines A need to be subjected to coordinate conversion and displayed. The coordinate conversion is explained with reference to FIG. 6. As shown in FIG. 6, if a maximum in the x-axis direction is represented as xmax and a maximum in the y-axis direction is represented as ymax, vertexes at four corners of a display region are represented as (0, 0), (xmax, 0), (0, ymax), and (xmax, ymax). If an arbitrary coordinate value of the line B in the regular direction is represented as (x1, y1), the coordinate value is equivalent to a position of (xmax−x1, ymax−y1) on the line A. If the processor 10 causes the line B to emit light, for example, in red in the coordinate (x1, y1) of the line B, the processor 10 simultaneously performs the coordinate conversion and causes the line A to also emit light in red in the coordinate (xmax−x1, ymax−y1) of the line A. By converting the other coordinate values in the same manner, an image is projected in the regular direction for the users present in all positions.

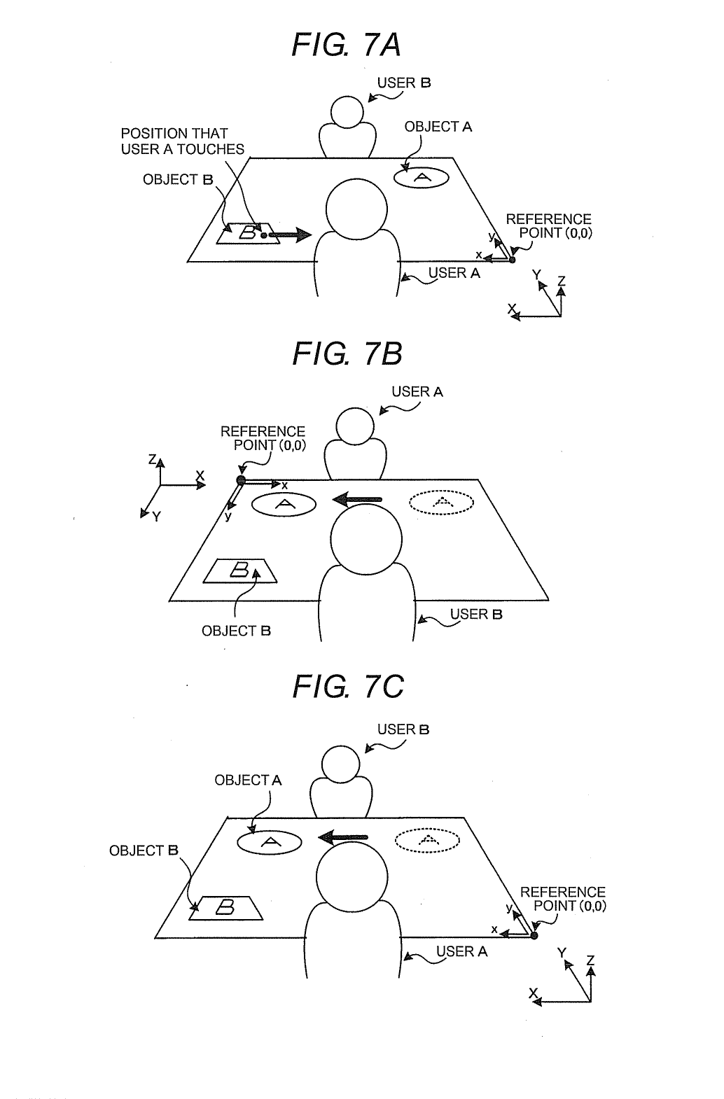

If the display control is performed such that the objects A and B are displayed in the regular direction for each of the users in this way, problems that occur when only display is controlled are explained. As an example, a situation in which the user A is about to move the object B is shown in FIG. 7A. FIG. 7A illustrates a situation in which the user A touches the object B and moves the object B in the right direction for the user A. If the object B is moved in the right direction, in the case of the control of only the display, for the user B, the object A moves (see FIG. 7B). For the user A, the object B does not move and the object A moves (see FIG. 7C).

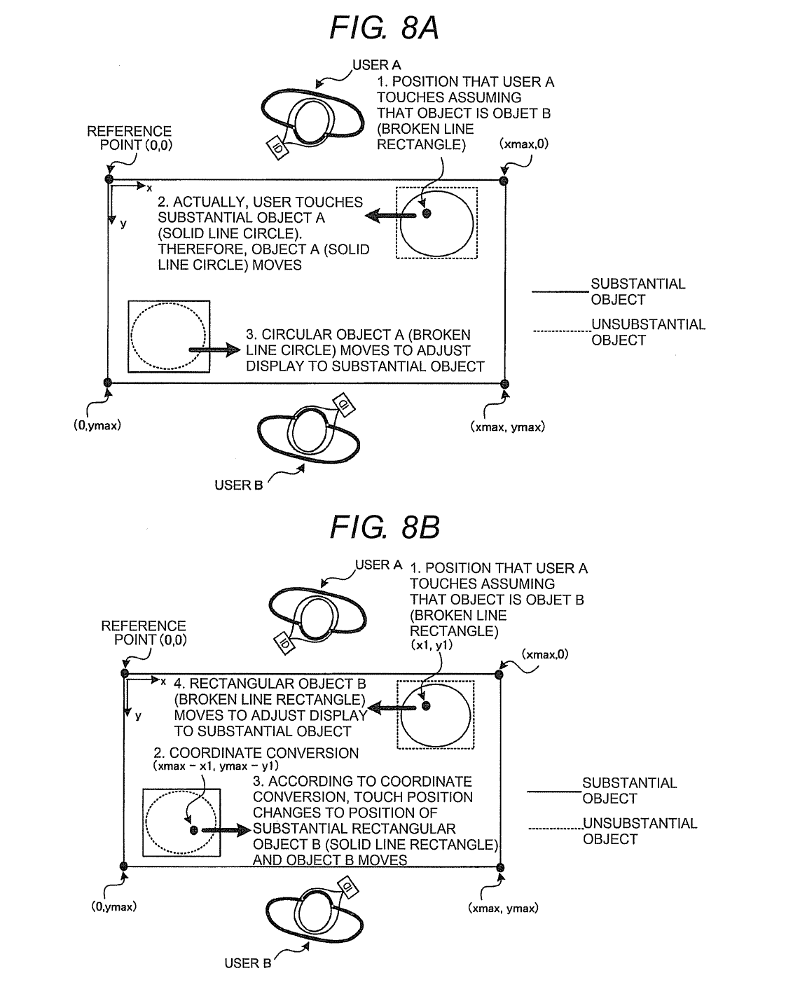

A reason for the above is explained with reference to FIG. 8A. In FIG. 8A, an object indicated by a solid line is an object visually recognized by the user B. That is, the object indicated by the solid line is an object displayed by the lines B and is an object that can be correctly visually recognized vertically as it is without being subjected to the coordinate conversion on the display. Such an object is referred to as substantial object. An object indicated by a broken line is an object that can be visually recognized by the user A. That is, the object indicated by the broken line is an object displayed by the lines A and is an object that can be correctly visually recognized vertically in a state in which the object is subjected to the coordinate conversion on the display. Such an object is referred to as unsubstantial object.

Actually, the substantial object A is present in a position that the user touches determining that the object is the object B (a broken line rectangle). Therefore, if the user A moves the touch position, the substantial object A moves following the touch position. Consequently, the user B visually recognizing the substantial object A sees as if the object A moves rather than the object B. In this case, according to the display conversion, the unsubstantial object A moves if the substantial object A moves. Consequently, the user A sees as if the object A moves. Therefore, even if the user A performs operation for moving the object B, both of the user A and the user B see as if the object A moves. In the case illustrated above, the substantial object A is present in the position that the user A touches determining that the object is the object B. However, if no object is present in the position that the user A touches determining that the object is the object B, both the objects A and B do not move.

In this embodiment, to solve this problem, not only the display conversion but also conversion of a touch position (a contact position) is performed. An example of a conversion method for the touch position is explained with reference to FIG. 8B. If the user A touches an arbitrary position (x1, y1) in the unsubstantial object B, as in the display conversion, the processor 10 converts the touch position to be the coordinate (xmax−x1, ymax−y1). According to the coordinate conversion of the touch position, the touch position changes to a position of the substantial object B. If the user A moves the touch position, the substantial object B moves. Consequently, the user B can visually recognize as if the object B is moving. Since the display conversion is also performed, if the substantial object B moves, the unsubstantial object B also moves. Consequently, the user A can visually recognize as if the object B is moving. In this way, the processor 10 performs the coordinate conversion for the touch position in addition to the display conversion. Therefore, it is possible to eliminate the inconsistency explained above.

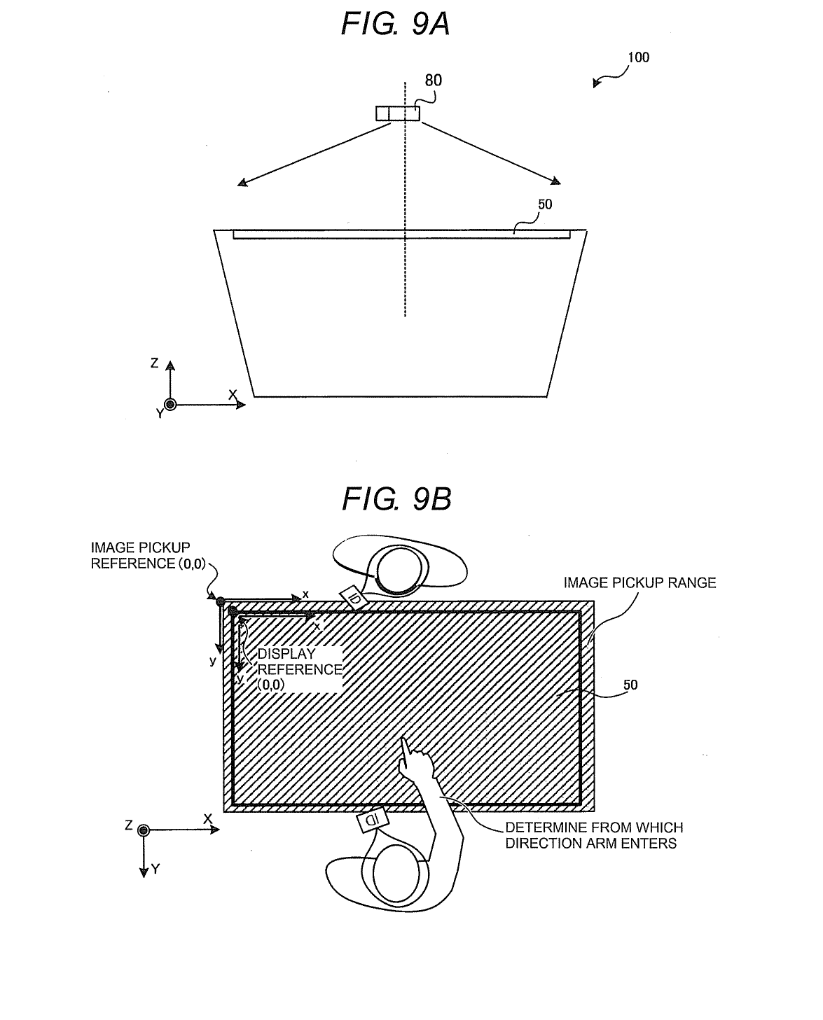

If the user B touches the substantial object, the user B directly touches the substantial object. Therefore, both of the display conversion and the coordinate conversion for the touch position are unnecessary. Therefore, the processor 10 needs to determine which of the users present in the four sides of the table of the tabletop information processing apparatus 100 touches the object, and to control, according to a result of the determination, whether the touch position is to be converted or not to be converted. To determine whether the user present in which position of the table performs operation, in this embodiment, an image of the touch panel display 50 is picked up using the camera 80. This configuration example is shown in FIGS. 9A and 9B. The camera 80 is located above the touch panel display 50 in this embodiment (see FIG. 9A). The camera 80 is arranged to be located right above the center axis of the touch panel display 50. The camera 80 picks up an image including the entire surface of the touch panel display 50 as shown in FIG. 9B. The camera 80 is arranged and set such that the picked-up image has a reference point same as the reference point of the coordinate system of the touch panel display 50 and has a coordinate axis in a direction same as the direction of the coordinate axis of the coordinate system.

The camera 80 picks up an image of the touch panel display 50 on a real-time basis. If the processor 10 detects contact on the touch panel display 50, the processor 10 acquires a picked-up image at the time of detection of the contact from the camera 80. The processor 10 specifies a touch position in the acquired picked-up image. The processor 10 determines, using the image processing in the past such as edge detection processing, from which of the four sides of the table an edge line extends to the touch position. Consequently, the processor 10 can specify from which of the four sides of the table an arm enters. Depending on a state of the picked-up image, the processor 10 detects entering of a plurality of arms. However, the processor 10 can specify the touch position. Therefore, by specifying an edge line extending from the detected touch position (or the vicinity of the touch position) out of the plurality of arms (edge lines), the processor 10 can specify from which of the four sides of the table the arm enters and comes into contact with the touch position.

In the example explained above, the method of vertically reversing the coordinate value of the user B present in the position where the user B can regularly visually recognize the objects and converting the coordinate value such that the user A can also regularly visually recognize the objects is explained. However, it is also possible to cause users C and D shown in FIG. 3 to regularly visually recognize the objects with the same method. If the coordinate value in the user B is represented as, for example, (x1, y1), a converted coordinate in the case of the user C is (xmax−y1, x1) and a converted coordinate in the case of the user D is (y1, ymax−x1). If a longitudinal length and a lateral length of the touch panel display 50 are different as in this example, it is possible to keep the coordinate values after the conversion within the display region by further multiplying the coordinate values with a ratio of xmax and ymax. As the lenticular lens 51 of the touch panel display 50, a lenticular lens that can be visually recognized differently on the four directions is adopted. The processor 10 divides the lines to vary the display panel of the touch panel display 50 in the four directions and performs display control.

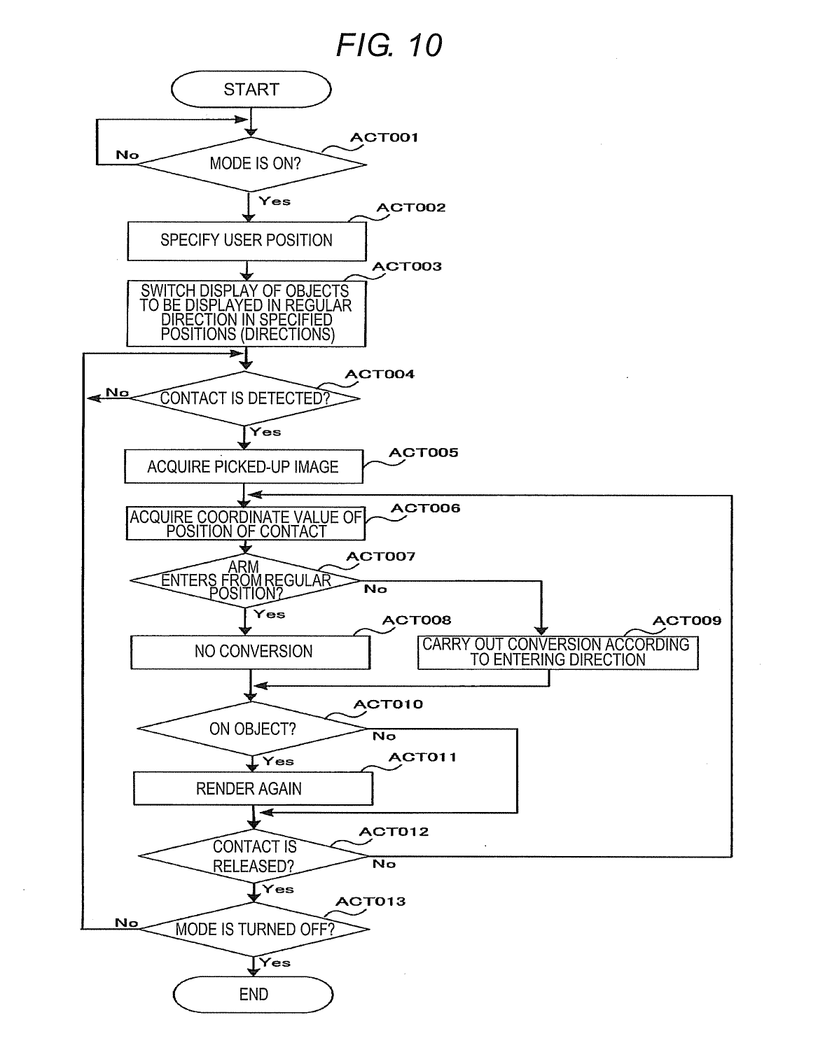

FIG. 10 is a flowchart showing an operation example in the embodiment. The processor 10 expands, in the DRAM 20, a computer program stored in the HDD 40 beforehand and arithmetically executes the computer program to carry out the flowchart according to a program code of the computer program.

The processor 10 determines whether a display switching mode is ON (ACT 001). The processing stays on standby until the display switching mode is turned on (ACT 001, a loop of No). The switching of the mode is performed by pressing a predetermined button displayed on the touch panel display 50. If the mode is turned on (ACT 001, Yes), the processor 10 specifies a position of a user (ACT 002). The user position is specified according to, for example, which of the sensors 70A to 70D detects an ID card owned by the user.

The processor 10 switches, according to the method explained above and using the coordinate conversion formula explained above, display of objects to be displayed in the regular direction respectively in specified directions (ACT 003).

If the touch panel display 50 detects contact (a touch), the processor 10 acquires a present picked-up image from the camera 80 (ACT 005) and acquires a coordinate value of a position where the contact is performed on the touch panel display 50 (ACT 006). The processor 10 determines, on the basis of the picked-up image and the contact coordinate value, whether an arm enters from a regular position (ACT 007). The regular position is a position where a vertical direction can be correctly visually recognized even in a normal display state before the switching of the mode. If the arm enters from the regular position (ACT 007, Yes), the processor 10 does not convert the touch position (ACT 008). On the other hand, if the arm does not enter from the regular position (ACT 007, No), the processor 10 further determines from which direction the arm enters. The processor 10 carries out conversion of the touch position according to the direction (ACT 009).

The processor 10 determines whether a substantial object is present in a coordinate after the conversion (if the conversion is unnecessary, the touch position) (ACT 010). If the substantial object is present (ACT 010, Yes), the processor 10 renders the substantial object again to move to the contact position and renders to an unsubstantial object again (ACT 011) If the substantial object is absent (ACT 010, No), the processor 10 proceeds to ACT 012.

ACT 006 to ACT 011 are repeatedly performed until the user releases the fingertip or the nib, that is, the contact with the touch panel display 50 is released (ACT 012, a loop of No). According to this repeated processing, if the user moves the fingertip or the nib, the objects also move following a moving position of the fingertip or the nib. The processor 10 repeatedly executes ACT 004 to ACT 012 until the mode is turned off (Act 013, a loop of No). If the mode is turned off, the processing ends.

### Second Embodiment

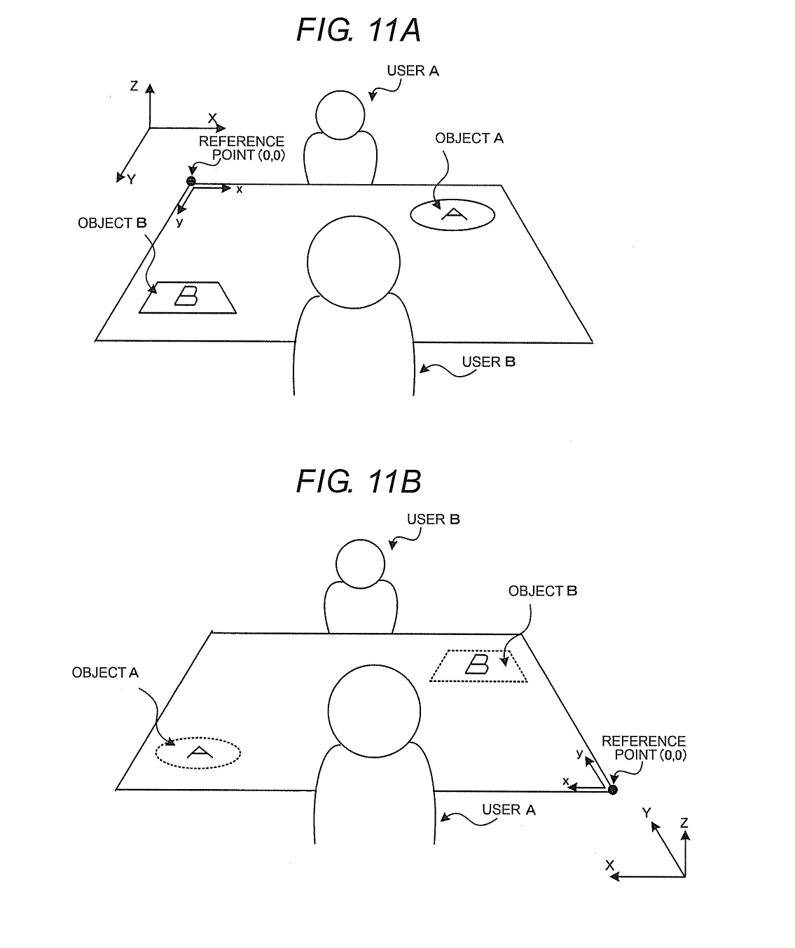

In the first embodiment, the objects are displayed in the regular direction with respect to the users. The display positions of the objects are controlled to coincide with each other with respect to the users. In a second embodiment, only the directions of the objects are controlled to be the regular direction with respect to the users. FIGS. 11A and 11B are diagrams showing a display example in the second embodiment. An apparatus configuration and the like are the same as those in the first embodiment. Therefore, explanation thereof is omitted (see FIGS. 1 to 4B). Reference numerals and signs in the first embodiment are also used in the second embodiment.

FIG. 11A is a display example of the objects visually recognized by the user B. For the user B, the object A is arranged at the upper right of the screen of the touch panel display 50 and the object B is arranged at the lower left of the screen. Both the objects A and B are arranged to be displayed in the regular direction with respect to the user B.

How the objects are seen from the user A facing the user B in a state of such arrangement is shown in FIG. 11B. In the second embodiment, display positions of the objects with respect to a reference point (a reference point (0, 0) in the figure) of the touch panel display 50 do not change. In the case of this example, while the object A maintains the upper right position for the user B and the object B maintains the lower left position for the user B, the objects are respectively displayed by being rotated 180 degrees so that the directions of the display of the objects are aligned in the direction that the user A can easily recognize. For the user A, the object B is arranged at the upper right on the screen and the object A is arranged at the lower left of the screen. The objects are displayed in the regular direction for the user A as well.

In the second embodiment, the processor 10 controls the display of the lines A (see FIGS. 4A and 4B) of the touch panel display 50 not to change the positions of the centers or the positions of the centers of gravity of the objects. The processor 10 controls the display of the line A of the touch panel display 50 such that the display of the objects is rotated 180 degrees about the center points (the center of gravity points) of the objects.

In a form of the second embodiment, coordinate values of the display positions of the objects do not change. Therefore, if operation for moving the objects is performed, the conversion of the touch position explained in the first embodiment is unnecessary. Therefore, the processing for detecting which of users touches the object, the mechanism for the detection, and the like are also unnecessary. Each of the objects is rotated at 90 degrees or 270 degrees and displayed for the user C and the user D not present in the facing positions. Therefore, the objects are displayed in the regular direction for the users.

The tabletop information processing apparatus 100 may switch and carry out the form of the first embodiment and the form of the second embodiment according to switching of a mode.

In the embodiments, the movement of the objects is mentioned. However, the embodiments can also be applied to rotation, enlargement, and reduction of the objects.

As in the embodiments, by setting the vertical direction of the display in the regular direction, not only the display but also a character input can be performed in the regular direction. For example, in an input of the number of print copies of an object, if a user in the opposite direction manually inputs, for example, “print 16 copies”, it is possible to prevent a situation in which the number of print copies is printed as 91 copies by mistake.

In the embodiments, the forms of the tabletop information apparatus are explained. However, forms of the embodiments are not limited to the forms of the tabletop information apparatus. The embodiments only have to be a computer including a touch panel display such as a tablet computer.

In the embodiments, an implementation example is explained in which the camera is set above the touch panel display and the position of the touching user is specified using the camera. Besides, various implementations are conceivable such as a method of setting the users as image pickup targets and detecting motions of the users and a configuration including a human body communication function. In the case of the human body communication function, the human body communication function is imparted to an ID card owned by a user, a chair on which the user is seated, and the like. If a fingertip of the user comes into contact with the touch panel display 50, identification information of the ID card owned by the user can be acquired using the human body as a transmission medium. The processor 10 specifies a position of the touching user on the basis of the identification information and information detected by the sensors 70A to 70D. The ID card may be hung from a neck or may be stored in a pocket. Naturally, the tabletop information processing apparatus 100 needs to include a unit that enables the human body communication.

A control section is equivalent to a component including at least the processor 10, the DRAM 20, and a communication bus 90 in the embodiment. A computer program operating in cooperation with the respective kinds of hardware such as the processor 10, the DRAM 20, and the communication bus 90 is stored in the HDD 40 (or the ROM 30) beforehand, loaded to the DRAM 20 by the processor 10, and arithmetically executed. A detecting section is equivalent to the sensor unit 70. A polarizing filter is equivalent to the lenticular lens 51.

A computer program for causing a computer to execute the functions explained in the embodiments may be provided. The computer program may be referred to by any name such as display control program, user interface program, device control program, and the like.

In the embodiments, the function for carrying out the invention is recorded in the apparatus in advance. However, the same function may be downloaded from a network to the apparatus. The same function stored in a recording medium may be installed in the apparatus. A form of the recording medium may be any form as long as the recording medium is a recording medium that can store a computer program and readable by the apparatus such as a CD-ROM. The function obtained by the installation or the download in advance may be realized in cooperation with an OS (operating system) or the like in the apparatus.

As explained above in detail, irrespective of in which direction a user is present, it is possible to perform regular display and prevent visibility of the user from being deteriorated.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touch panel display including a polarizing filter; and
a control section configured to control display of the touch panel display such that display content visually recognized via the polarizing filter is displayed in a regular direction in each of positions of a plurality of users present around side surfaces of the touch panel display when a display operation surface of the touch panel display is directed in an upward direction.

2. The apparatus according to claim 1, wherein the control section converts coordinate values of the touch panel display using a conversion formula defined beforehand for each of visual recognition directions and converts contact coordinates of the touch panel display using the conversion formula for each of the visual recognition directions.

3. The apparatus according to claim 2, wherein the control section determines directions of presence of users who are operating the touch panel display and converts, for each of the determined directions, the contact coordinate of the touch panel display using the conversion formula.

4. The apparatus according to claim 1, wherein the control section controls the display of the touch panel display such that a position of an image displayed on the touch panel display is a same position with respect to a reference point of the touch panel display and a direction of the image is the regular direction in each of the positions of the users present around the side surfaces of the touch panel display.

5. The apparatus according to claim 3, wherein the control section acquires an image obtained by picking up an image of a display operation surface of the touch panel display and determines, on the basis of the picked-up image, the directions of the presence of the users who are operating the touch panel display.

6. A method of controlling an information processing apparatus which including a touch panel display including a polarizing filter, comprising the steps of:
specifying each of positions of a plurality of users present around side surfaces of the touch panel display when a display operation surface of the touch panel display is directed in an upward direction; and
controlling display of the touch panel display such that display content visually recognized via the polarizing filter of the touch panel display is displayed in a regular direction in each of the positions where the plurality of users are present.

7. The method according to claim 6, further comprising:
converting coordinate values of the touch panel display using a conversion formula defined beforehand for each of visual recognition directions and converting contact coordinates of the touch panel display using the conversion formula for each of the visual recognition directions.

8. The method according to claim 7, further comprising:
determining directions of presence of users who are operating the touch panel display and converts, for each of the determined directions, the contact coordinate of the touch panel display using the conversion formula.

9. The method according to claim 6, further comprising:
displaying such that a position of an image displayed on the touch panel display is a same position with respect to a reference point of the touch panel display and a direction of the image is the regular direction in each of the positions of the users present around the side surfaces of the touch panel display.

10. A computer-readable storage medium storing a program for causing a computer to execute processing, wherein the computer including a touch panel display including a polarizing filter, the steps:
specifying each of positions of a plurality of users present around side surfaces of the touch panel display when a display operation surface of the touch panel display is directed in an upward direction; and
controlling display of the touch panel display such that display content visually recognized via the polarizing filter of the touch panel display is displayed in a regular direction in each of the positions where the plurality of users are present.
